(19) United States
(12) Patent Application Publication
(10) Pub. No.: US 2020/0194749 A1
(43) Pub. Date: Jun. 18, 2020

(54) PRELITHIATED ANODE IN BATTERY CELLS FOR ELECTRIC VEHICLES

(71) Applicant: TeraWatt Technolgy Inc., Santa Clara, CA (US)

(72) Inventors: Ken Ogata, Santa Clara, CA (US); Hiroshi Imoto, Santa Clara, CA (US)

(21) Appl. No.: 16/220,965

(22) Filed: Dec. 14, 2018

(51) Int. Cl. H01M 2/10; H01M 4/134; H01M 4/38; H01M 10/0525; H01M 2/30

(52) U.S. Cl. CPC H01M 2/1077; H01M 4/134; H01M 4/386; H01M 2004/021; H01M 2/30; H01M 2220/20; H01M 10/0525

(57) ABSTRACT

Provided herein are systems, apparatuses, and methods of providing electrical energy for electric vehicles. A battery pack can be disposed in an electric vehicle to power the electric vehicle. A battery cell can be arranged in the battery pack. The battery cell can have a housing. The housing can define a cavity within the housing. The battery cell can have an electrolyte arranged within the cavity. The battery cell can have a cathode disposed within the cavity along one side of the electrolyte. The battery cell can have an anode disposed within the cavity along another side of the electrolyte. The anode can have a silicon-carbon structure. The silicon-carbon structure can be doped with lithium material prior to an initial charge cycle of the battery cell. The anode can have a negative electrode capacity 20-50% greater than a positive electrode capacity of the cathode.

### BACKGROUND

Batteries can include electrochemical cells to supply electrical power to various electrical components connected thereto.

### SUMMARY

The present disclosure is directed to batteries cells for battery packs in electric vehicles, for example.

At least one aspect is directed to an apparatus to power electrical energy for electric vehicles. The apparatus can include a battery pack. The battery pack can be disposed in an electric vehicle to power the electric vehicle. The apparatus can include a battery cell. The battery cell can be arranged in the battery pack. The battery cell can have a housing. The housing can define a cavity within the housing of the battery cell. The battery cell can have an electrolyte. The electrolyte can have a first side and a second side. The electrolyte can transfer ions between the first side and the second side. The electrolyte can be arranged within the cavity. The battery cell can have a cathode. The cathode can be disposed within the cavity along the first side of the electrolyte. The cathode can be electrically coupled with a positive terminal. The cathode can have a positive electrode capacity. The battery cell can have an anode. The anode can be disposed within the cavity along the second side of the electrolyte. The anode can have a silicon-carbon structure. The silicon-carbon structure can be doped with lithium material prior to an initial charge cycle of the battery cell. The anode can have a negative electrode capacity 20-50% greater than the positive electrode capacity of the cathode. The anode can be electrically coupled with a negative terminal.

At least one aspect is directed to a method of providing battery cells to power electric vehicles. The method can include disposing a battery pack in an electric vehicle to power the electric vehicle. The method can include arranging a housing for a battery cell in the battery pack. The housing can define a cavity within the housing for the battery cell. The method can include arranging, within the cavity of the battery cell, an electrolyte. The electrolyte can have a first side and a second side to transfer ions between the first side the second side. The method can include disposing, within the cavity of the battery cell, a cathode along the first side of the electrolyte. The cathode can be electrically coupled with a positive terminal. The cathode can have a positive electrode capacity. The method can include disposing, within the cavity, an anode along the second side of the electrolyte. The anode can be electrically coupled with the negative terminal. The anode can have a silicon-carbon structure. The silicon-carbon structure can be doped with lithium material prior to an initial charge cycle of the battery cell. The anode can have a negative electrode capacity 20-50% greater than the positive electrode capacity of the cathode. The anode can be electrically coupled with a negative terminal.

At least one aspect is directed to an electric vehicle. The electric vehicle can include one or more components. The electric vehicle can include a battery pack to power the one or more components. The electric vehicle can include a battery cell. The battery cell can be arranged in the battery pack. The battery cell can have a housing. The housing can define a cavity within the housing of the battery cell. The battery cell can have an electrolyte. The electrolyte can have a first side and a second side. The electrolyte can transfer ions between the first side and the second side. The electrolyte can be arranged within the cavity. The battery cell can have a cathode. The cathode can be disposed within the cavity along the first side of the electrolyte. The cathode can be electrically coupled with a positive terminal. The cathode can have a positive electrode capacity. The battery cell can have an anode. The anode can be disposed within the cavity along the second side of the electrolyte. The anode can have a silicon-carbon structure. The silicon-carbon structure can be doped with lithium material prior to an initial charge cycle of the battery cell. The anode can have a negative electrode capacity 20-50% greater than the positive electrode capacity of the cathode. The anode can be electrically coupled with a negative terminal.

At least one aspect is directed to a method. The method can include providing an apparatus. The apparatus can be included in an electric vehicle. The apparatus can include a battery cell. The battery cell can be arranged in the battery pack. The battery cell can have a housing. The housing can define a cavity within the housing of the battery cell. The battery cell can have an electrolyte. The electrolyte can have a first side and a second side. The electrolyte can transfer ions between the first side and the second side. The electrolyte can be arranged within the cavity. The battery cell can have a cathode. The cathode can be disposed within the cavity along the first side of the electrolyte. The cathode can be electrically coupled with a positive terminal. The cathode can have a positive electrode capacity. The battery cell can have an anode. The anode can be disposed within the cavity along the second side of the electrolyte. The anode can have a silicon-carbon structure. The silicon-carbon structure can be doped with lithium material prior to an initial charge cycle of the battery cell. The anode can have a negative electrode capacity 20-50% greater than the positive electrode capacity of the cathode. The anode can be electrically coupled with a negative terminal.

At least one aspect is directed to a battery cell. The battery cell can provide power to an electric vehicle. The battery cell can be disposed in a battery pack. The battery pack can be disposed in an electric vehicle to at least partially power the electric vehicle. The battery cell can have a housing that defines a cavity within the housing of the battery cell. The battery cell can include an electrolyte having a first side and a second side to transfer ions between the first side and the second side. The electrolyte can be arranged within the cavity. The battery call can include a cathode disposed within the cavity along the first side of the electrolyte. The cathode can be electrically coupled with a positive terminal. The cathode can have a positive electrode capacity. The battery cell can include an anode disposed within the cavity along the second side of the electrolyte. The anode can have a silicon-carbon structure doped with lithium material prior to an initial charge cycle of the battery cell. The anode can have a negative electrode capacity 20-50% greater than the positive electrode capacity of the cathode. The anode can be electrically coupled with a negative terminal.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is an isometric cross-sectional perspective of an example battery cell for powering electric vehicles;

FIG. 2 is a cross-sectional block diagram of an example battery cell for powering electric vehicles;

FIG. 3 is a block diagram depicting a cross-sectional view of an example apparatus for powering electric vehicles;

FIG. 4 is a block diagram depicting a top-down view of an example apparatus for powering electric vehicles;

FIG. 5 is a block diagram depicting a cross-sectional view of an example electric vehicle installed with a battery pack;

FIG. 6 is a flow diagram depicting an example method of assembling battery cells for battery packs for electric vehicles; and

FIG. 7 is a flow diagram depicting an example of method of providing battery cells for battery packs for electric vehicles.

### DETAILED DESCRIPTION

Following below are more detailed descriptions of various concepts related to, and implementations of battery cells for battery packs in electric vehicles. The various concepts introduced above and discussed in greater detail below can be implemented in any of numerous ways.

Described herein are battery cells for battery packs in electric vehicles for an automotive configuration. An automotive configuration includes a configuration, arrangement or network of electrical, electronic, mechanical or electromechanical devices within a vehicle of any type. An automotive configuration can include battery cells for battery packs in electric vehicles (EVs). EVs can include electric automobiles, cars, motorcycles, scooters, passenger vehicles, passenger or commercial trucks, and other vehicles such as sea or air transport vehicles, planes, helicopters, submarines, boats, or drones. EVs can be fully autonomous, partially autonomous, or unmanned.

Lithium-ion battery cells can be used in the electric vehicle and other settings to power the components and store electrical energy for such components. In lithium-ion battery cells, lithium ions can move from a positive electrode to a negative electrode during charging and move back from the negative electrode to the positive electrode during discharge. Each component of the lithium-ion battery cell can be comprised at least in part in lithium material or another substance to carry the lithium ions through the battery cell. The cathode of the lithium-ion battery cell can be comprised of a lithium-based oxide material. The electrolyte of the lithium-ion battery cell can also be comprised of a lithium compound in the form of a salt dissolved in liquid or a solid powder, or can be comprised of a polymer material. The anode of the lithium-ion can be comprised of lithium-based or graphite.

The use of lithium or graphite in the anode can raise a myriad of technical challenges in the operation and endurance of the lithium ion battery cells. For example, with repeated charging and discharging of the battery cell, lithium material can become accumulate in the anode of the battery cell. Moreover, uneven distribution of the lithium material can result in dendritic growth of the lithium. The dendritic growth of the lithium in the anode can eventually pierce the electrolyte and contact the cathode, resulting in short circuiting or failure of the battery cell. In addition, the rate of charging of the battery cell can be constrained by the employment of lithium-based compound or graphite in the anode cell, due to the energy capacity of lithium or graphite. Slower rates of charging can hinder the reuse of the battery cell after discharge and depletion of stored electrical energy.

The incorporation of other materials such as silicon-based compound (e.g., silicon-carbon) can alleviate the dendritic growth of the lithium along the anode side of the battery cell and can boost the rate of charging of the lithium-ion battery cell. The inclusion of silicon in the anode of the battery cell can reduce the likelihood of dendritic growth of the lithium by absorbing lithium ions received via the electrolyte. Lithium-based or graphite-based anodes may lack the capability of absorbing lithium ions as much as silicon can. Furthermore, the use of silicon can potentially increase the rate of charging of the battery cell. Compared to lithium-based or graphite compounds, silicon can have a higher energy density.

Incorporating silicon-based compounds into the anode can offer advantages relative to lithium-based or graphite anodes, but such incorporation into the anode of a lithium-ion battery cell can be difficult. For example, a silicon-based anode can absorb and consume the lithium ions received via the electrolyte along the surface between the anode and electrolyte, leading to parasitic irreversibility with the lithium retained the anode even with discharge. With recurring charging and discharging of the lithium ion battery cell, a solid electrolyte interface (SEI) can form between the silicon-based anode and the electrolyte. The formation of the SEI can increase the electrical resistance through the battery cell, thereby reducing the output electric power, and can also shorten the lifespan of the battery cell.

In addition, the absorption of the lithium ions received via the electrolyte can lead to volume expansion of the silicon of the anode (e.g., as much as 300% swelling). The volume expansion may be because the occupation of the lithium ions within the lattice structure of the silicon in the anode can widen the spacing between each silicon atom within the structure. The swelling of the silicon can result in the enlargement of the battery cell volume and eventually to the fracturing of the silicon in the anode. The expansion can also lead to mechanical failure of the housing containing the contents of the battery cell and to the lessening of the lifespan of the battery cell. Higher concentrations of silicon can exacerbate these deleterious effects.

To resolve technical challenges arising from incorporating silicon into the anode, a pre-lithiated, porous silicon-carbon (SiC) structure with appropriate parameters can be used as the anode of the lithium-ion battery cell. The negative-to-positive (NP) capacity ratio of the battery cell with a silicon-based compound as the anode can be fabricated to range between 1.2 to 1.5. To juxtapose, battery cells with NP capacity ratios of between 1.0 to 1.1 have the desirable property of higher energy density, whereas battery cells with NP capacity ratios of between 1.2 and 1.5 have the undesirable property of lower energy density. The decrease energy density of the battery cell can be offset by the specific capacity of the anode ranging between 500 mAh/g to 2,500 mAh/g. However, the battery cells with NP capacity ratios of between 1.0 to 1.1 can suffer from parasitic irreversibility with lithium ions accumulating between the anode and electrolyte. In contrast, battery cells with the higher NP capacity ratio of 1.2 to 1.5 can lessen the deleterious effects of parasitic irreversibility.

The silicon-carbon structure in the anode of the battery cell can be prelithiated with concentrations ranging 3% to 50% to compensate the decrease in energy capacity resulting from the higher NP capacity ratio of 1.2 to 1.5. In comparison, battery cells with lower NP capacity ratios of 1.0 to 1.1 and silicon-based anode may be designed with lower concentrations or no pre-doped lithium (e.g., less than 3%) to account for swelling by allowing lithium ions from the electrolyte to reside in the anode. But the prelithiation dose can cancel the initial reaction leading to the parasitic irreversibility (e.g., as much as 20% to 30%) and can lower the risk of lithium plating in the anode. The dose of lithium can also provide a lithium reservoir to increase the energy capacity of the anode.

Pre-doping the silicon with lithium can allow for a thinner and less dense anode in the lithium-ion battery cell. The silicon structure can be a silicon carbon composite that can be porous and nanostructured to account to reduce volume expansion. In anodes without such configurations, the density of the anode material (e.g., graphite or silicon-graphite) can be high as 1.6 g/cc with energy density and electrical conductivity in mind. In the silicon-carbon anode, however, such considerations can be addressed by pre-doping with lithium. As a result, the tap density of the active material (e.g., silicon) can be lowered to 1.3 g/cc to allow for some volume expansion upon lithiation from charging of the battery cell. The lower tap density of the active material can reduce the amount of swelling of the silicon (e.g., as much as 30% to 50%), as there is space between the silicon for the lithium ions from the electrolyte to occupy. The lower tap density can be also compensated by having a higher gravimetric capacity of the active material set to 800 mAh/cc to 3000 mAh/cc. In this manner, the battery cell with pre-lithiated, porous silicon-carbon (SiC) structure configured in this manner can reduce or eliminate parasitic irreversibility and volume expansion.

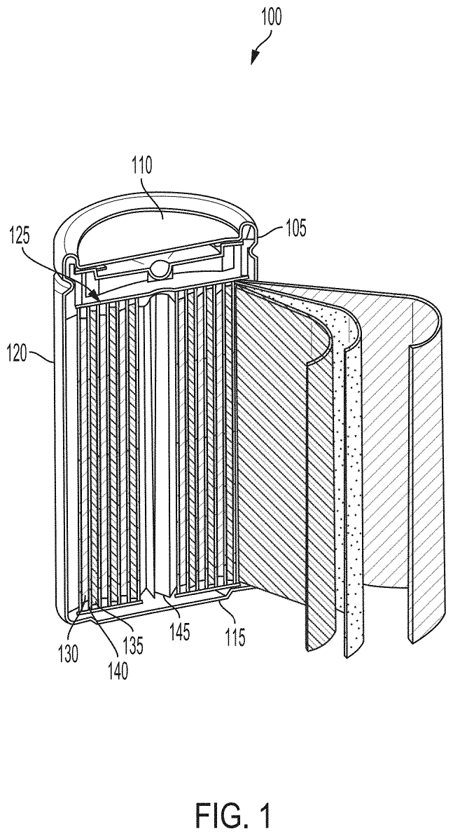

FIG. 1, among others, depicts an isometric, cross-sectional view of a battery cell 100 for powering electric vehicles. The battery cell 100 can be part of a system or an apparatus for powering components of electric vehicles, and that can include a battery pack and other components to power the electric vehicle or other device. The battery cell 100 can be a lithium-ion battery cell to power electrical components (e.g., components of an electric vehicle or components other than those installed in electric vehicles). The battery cell 100 can be a solid state battery cell or a non-solid state battery cell. The battery cell 100 can include a housing 105. The housing 105 can be contained in a battery module, a battery pack, or a battery array installed in an electric vehicle. The housing 105 can be of any shape. The shape of the housing 105 can be cylindrical with a circular (e.g., as depicted), elliptical, or ovular base, among others. The shape of the housing 105 can also be prismatic with a polygonal base, such as a triangle, a square, a rectangle, a pentagon, and a hexagon, among others. The housing 105 can have a length (or height) ranging between 65 mm to 120 mm. The housing 105 can have a width (or diameter in cylindrical examples as depicted) ranging between 18 mm to 45 mm. The housing 105 can have a thickness ranging between 100 mm to 200 mm.

The housing 105 of the battery cell 100 can include one or more materials with various electrical conductivity or thermal conductivity, or a combination thereof. The electrically conductive and thermally conductive material for the housing 105 of the battery cell 100 can include a metallic material, such as aluminum, an aluminum alloy with copper, silicon, tin, magnesium, manganese or zinc (e.g., of the aluminum 1000, 4000, or 5000 series), iron, an iron-carbon alloy (e.g., steel), silver, nickel, copper, and a copper alloy, among others. The electrically insulative and thermally conductive material for the housing 105 of the battery cell 100 can include a ceramic material (e.g., silicon nitride, titanium carbide, zirconium dioxide, beryllium oxide, and among others) and a thermoplastic material (e.g., polyethylene, polypropylene, polystyrene, polyvinyl chloride, or nylon), among others.

The housing 105 of the battery cell 100 can have at least one lateral surface, such as a top surface 110 and a bottom surface 115. The top surface 110 can correspond to a top lateral side of the housing 105. The top surface 110 can be an integral portion of the housing 105. The top surface 110 can be separate from the housing 105, and added onto the top lateral side of the housing 105. The bottom surface 115 can correspond to a bottom lateral side of the housing 105, and can be on the opposite side of the top surface 110. The bottom surface 115 can correspond to a top lateral side of the housing 105. The bottom surface 115 can be an integral portion of the housing 105. The top surface 110 can be separate from the housing 105, and added onto the top lateral side of the housing 105. The housing 105 of the battery cell 100 can have at least one longitudinal surface, such as a sidewall 120. The sidewall 120 can extend between the top surface 110 and the bottom surface 115 of the housing 105. The sidewall 120 can have an indented portion (sometimes referred herein to as a neck or a crimped region) thereon. The top surface 110, the bottom surface 115, and the sidewall 120 can define a cavity 125 within the housing 105. The cavity 125 can correspond to an empty space, region, or volume within the housing 105 to hold content of the battery cell 100. The cavity 125 can span within the top surface 110, the bottom surface 115, and the sidewall 120 of the housing 105.

The battery cell 100 can include at least one cathode layer 130 (sometimes herein generally referred to as a cathode). The cathode layer 130 can be situated, arranged, or otherwise disposed within the cavity 125 defined by the housing 105. At least a portion of the cathode layer 130 can be in contact or flush within an inner side of the side wall 120. At least a portion of the cathode layer 130 can be in contact or flush with an inner side of the bottom surface 115. The cathode layer 130 can output conventional electrical current out from the battery cell 100 and can receive electrons during the operation of the battery cell 100. The cathode layer 130 can also release lithium ions during the operation of the battery cell 100. The cathode layer 130 can be comprised of a solid cathode material, such as a lithium-based oxide materials or phosphates. The cathode layer 130 can be comprised of Lithium Cobalt Oxide (LiCoO₂), Lithium Iron Phosphate (LiFePO₄), Lithium Manganese Oxide (LiMn2O4), Lithium Nickel Manganese Cobalt Oxide (LiNiₓMn_{y}Co_{z}O₂), Lithium Nickel Cobalt Aluminum Oxide (LiNiCoAlO₂), among other lithium-based materials. The cathode layer 130 can have a length (or height) ranging between 50 mm to 120 mm. The cathode layer 130 can have a width ranging between 50 mm to 2000 mm. The cathode layer 130 can have an areal loading ranging between 5 mg/cm² to 50 mg/cm². The cathode layer 130 can have a thickness ranging between 5 μm to 200 μm.

The battery cell 100 can include at least one anode layer 135 (sometimes herein generally referred to as an anode). The anode layer 135 can be situated, arranged, or otherwise disposed within the cavity 125 defined by the housing 105. At least a portion of the anode layer 135 can be in contact or flush within an inner side of the side wall 120. At least a portion of the anode layer 135 can be in contact or flush with an inner side of the bottom surface 115. The anode layer 135 can receive conventional electrical current into the battery cell 100 and output electrons during the operation of the battery cell 100 (e.g., charging or discharging of the battery cell 100). The anode layer 135 can be comprised of a solid anode material. For example, the anode layer 135 can be comprised of a silicon-carbon (carborundum) material. The anode layer 135 can have a length (or height) ranging between 50 mm to 120 mm. The anode layer 135 can have a width ranging between 50 mm to 2000 mm. The anode layer 135 can have an areal loading ranging between lmg/cm² to 50 mg/cm². The anode layer 135 can have a thickness ranging between 5 μm to 200 μm.

The battery cell 100 can include an electrolyte layer 140 (sometimes herein generally referred to as a solid electrolyte). The electrolyte layer 140 can be situated, disposed, or otherwise arranged within the cavity 125 defined by the housing 105. At least a portion of the electrolyte layer 140 can be in contact or flush within an inner side of the side wall 120. At least a portion of the electrolyte layer 140 can be in contact or flush with an inner side of the bottom surface 115. The electrolyte layer 140 can be arranged between the anode layer 135 and the cathode layer 130 to separate the anode layer 135 and the cathode layer 130. The electrolyte layer 140 can transfer ions between the anode layer 135 and the cathode layer 130. The electrolyte layer 140 can transfer cations from the anode layer 135 to the cathode layer 130 during the operation of the battery cell 100. The electrolyte layer 140 can transfer anions (e.g., lithium ions) from the cathode layer 130 to the anode layer 135 during the operation of the battery cell 100. The electrolyte layer 140 can have a length (or height) ranging between 50 mm to 115 mm. The electrolyte layer 140 can have a width ranging between 50 mm to 2000 mm. The electrolyte layer 140 can have a thickness ranging between 10 μm to 100 μm.

The electrolyte layer 140 can be comprised of a solid electrolyte material. The electrolyte layer 140 can be comprised of a ceramic electrolyte material, such as lithium phosphorous oxy-nitride (LiₓPO_{y}N_{z}), lithium germanium phosphate sulfur (Li₁₀GeP₂S₁₂), a material of the LGPS family (e.g., LiₐSi_{b}P_{c}S_{d}Clₑ, LiₐP_{c}S_{d}, LiₐGe_{b}P_{c}S_{d}), a lithium super ion conductor (e.g., Li₂₊₂ₓZn₁₋ₓGeO₄), lithium lanthanum titanate (LiₐLa_{b}Ti_{c}O_{d}), lithium lanthanum zirconate (LiₐLa_{b}Zr_{c}O_{d}.), Yttria-stabilized Zirconia (YSZ), NASICON (Na₃Zr₂Si₂PO₁₂), beta-alumina solid electrolyte (BASE), perovskite ceramics (e.g., strontium titanate (SrTiO₃)), among others. The electrolyte layer 140 can be comprised of a polymer electrolyte material, such as polyacrylonitrile (PAN), polyethylene oxide (PEO), polymethyl-methacrylate (PMMA), and polyvinylidene fluoride (PVDF), among others. The electrolyte layer 140 can be comprised of a glassy electrolyte material, such as lithium sulfide-phosphor pentasulfide (Li₂S—P₂S₅), lithium sulfide-boron sulfide (Li₂S—B₂S₃), and Tin sulfide-phosphor pentasulfide (SnS—P₂S₅). The electrolyte material 140 can include any combination of the ceramic electrolyte material, the polymer electrolyte material, and the glassy electrolyte material, among others. The electrolyte layer 140 can be comprised of a membrane to hold a liquid electrolyte material dissolved in an organic solvent. The membrane of the electrolyte layer 140 can store and maintain the liquid electrolyte material dissolved in the organic solvent. The liquid electrolyte material for the electrolyte layer 140 can include lithium tetrafluoroborate (LiBF₄), lithium hexafluorophosphate (LiPF₆), and lithium perchlorate (LiClO₄), among others. The organic solvent for the electrolyte layer 140 can include dimethyl carbonate (DMC), ethylene carbonate (EC), or diethyl carbonate (DEC), among others.

The battery cell 100 can include at least one center support 145. The center support 145 can be situated, arranged, or disposed within the cavity 125 defined by the housing 125. At least a portion of the center support 145 can be in contact or flush within an inner side of the side wall 120. At least a portion of the center support 145 can be in contact or flush with an inner side of the bottom surface 115. The center support 145 can be positioned in a hollowing defined by the anode layer 135, the cathode layer 130, or the electrolyte layer 140. The center support 145 in the hollowing can be any structure or member to wrap around the anode layers 130, the cathode layers 135, and the electrolyte layers 140 in stack formation. The center support 145 can include an electrically insulative material, and the center support 145 can function neither as the positive terminal nor the negative terminal for the battery cell 100. The battery cell 100 can also lack or not include the center support 145.

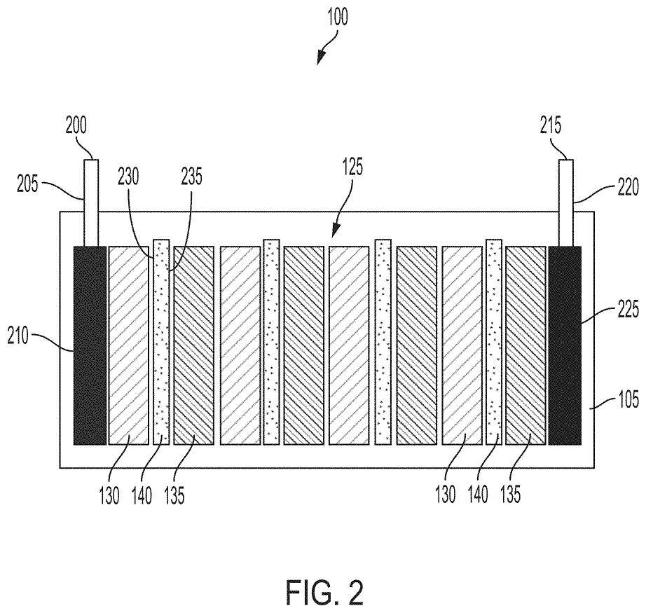

FIG. 2, among others, a cross-sectional view of the battery cell 100 for powering electric vehicles. As depicted, the battery cell 100 can include at least one positive terminal 200. The positive terminal 200 can correspond to an end at which conventional electrical current can be outputted from the battery cell 100 and electrons can be received during the operation of the battery cell 100 (e.g., charging or discharging of the battery cell 100). The positive terminal 200 can be defined anywhere on the housing 100, such as the top surface 110, the bottom surface 115, and the sidewall 120. For example, the positive terminal 200 can be defined along the top surface 110 of the housing 100. The positive terminal 200 can correspond to at least a portion of the top surface 110 of the housing 100. The positive terminal 200 can be electrically coupled with at least a portion of the top surface 110 of the housing 100. The positive terminal 200 can be electrically coupled with the cathode layer 135 disposed in the cavity 130 of the housing 100.

The battery cell 100 can include at least one positive bonding element 205. The positive bonding element 205 can correspond to an electrically conductive wire. The electrically conductive material for the positive bonding element 205 can include a metallic material, such as aluminum, an aluminum alloy with copper, silicon, tin, magnesium, manganese or zinc (e.g., of the aluminum 1000, 4000, or 5000 series), iron, an iron-carbon alloy (e.g., steel), silver, nickel, copper, and a copper alloy, among others. The positive bonding element 205 can extend partially within the cavity 125 defined by the housing 105. The positive bonding element 205 can correspond to the positive terminal 200 of the battery cell 100. The positive bonding element 205 can be electrically couple with the cathode layer 130 disposed in the cavity 125 of the housing 105 with the positive terminal 200 to carry conventional electrical current to the cathode layer 130.

The battery cell 100 can include at least one positive conductive layer 210. The positive conductive layer 210 can be disposed or arranged on one end of the cathode layer 130 disposed within the cavity 125 of the housing 105. The positive conductive layer 210 can be at least partially in physical contact with a portion (e.g., a top end as depicted or along a longitudinal side) of the cathode layer 130. The positive conductive layer 210 can electrical couple the positive bonding element 205 to the cathode layer 130 disposed within the cavity 125 of the housing 105. The positive conductive layer 210 can be attached, welded, bonded, or otherwise joined to the positive bonding element 205. The positive conductive layer 210 can carry conventional electrical current into the cathode layer 130 during operation of the battery cell 100. The electrically conductive material of the positive conductive layer 210 can include a metallic material, such as aluminum, an aluminum alloy with copper, silicon, tin, magnesium, manganese or zinc (e.g., of the aluminum 1000, 4000, or 5000 series), iron, an iron-carbon alloy (e.g., steel), silver, nickel, copper, and a copper alloy, among others. The electrically conductive material for the positive conductive layer 210 can also include carbon-based materials, such as graphite and carbon fiber, among others.

The battery cell 100 can include at least one negative terminal 215. The negative terminal 215 can correspond to an end at which conventional electrical current can be received into the battery cell 100 and electrons can be released during the operation of the battery cell 100. The negative terminal 215 can be defined anywhere on the housing 105, such as the top surface 110, the bottom surface 115, and the sidewalls 120. For example, the negative terminal 215 can be defined along the sidewall 120 of the housing 105. The negative terminal 215 can correspond to at least a portion of the sidewall 120 of the housing 105. The negative terminal 215 can be electrically coupled with at least a portion of the sidewall 120 of the housing 105. The negative terminal 215 can be electrically coupled with the anode layer 135 disposed in the cavity 125 of the housing 105.

The battery cell 100 can include at least one negative bonding element 220. The negative bonding element 220 can correspond to an electrically conductive wire. The electrically conductive material for the negative bonding element 220 can include a metallic material, such as aluminum, an aluminum alloy with copper, silicon, tin, magnesium, manganese or zinc (e.g., of the aluminum 1000, 4000, or 5000 series), iron, an iron-carbon alloy (e.g., steel), silver, nickel, copper, and a copper alloy, among others. The negative bonding element 220 can extend partially within the cavity 125 defined by the housing 105. The negative bonding element 220 can correspond to the negative terminal 215 of the battery cell 100. The negative bonding element 220 can electrically couple the anode layer 135 disposed in the cavity 125 of the housing 105 with the negative terminal 215 to carry conventional electrical current out of the anode layer 135.

The battery cell 100 can include at least one negative conductive layer 225. The negative conductive layer 225 can be disposed or arranged on one end of the anode layer 135 disposed within the cavity 125 of the housing 105. The negative conductive layer 225 can be at least partially in physical contact with a portion (e.g., a top end as depicted or along a longitudinal side) of the anode layer 135. The negative conductive layer 225 can electrical couple the negative bonding element 220 to the anode layer 135 disposed within the cavity 125 of the housing 105. The negative conductive layer 225 can be attached, welded, bonded, or otherwise joined to the negative bonding element 220. The negative conductive layer 225 can carry conventional electrical current out of the anode layer 135 during operation of the battery cell 100. The electrically conductive material of the negative conductive layer 225 can include a metallic material, such as an aluminum alloy with copper, silicon, tin, magnesium, manganese or zinc (e.g., of the aluminum 1000, 4000, or 5000 series), iron, an iron-carbon alloy (e.g., steel), silver, nickel, copper, and a copper alloy, among others. The electrically conductive material for the negative conductive layer 225 can also include carbon-based materials, such as graphite and carbon fiber, among others.

The battery cell 100 can have a set of cathode layers 130, a set of anode layers 135, and a set of electrolyte layers 140 arranged within the cavity 125 of the housing 105. The set of cathode layers 130, the set of anode layers 135, and the electrolyte layers 140 can be arranged in succession, stacked, or interleaved. At least one of the electrolyte layers 140 can separate one of the cathode layers 130 and one of the anode layers 135. At least one of the cathode layers 130 and at least one of the anode layers 135 can be separated without an electrolyte 140 between the cathode layer 130 and the anode layer 135. At least one of the cathode layers 130 and at least one of the anode layers 135 can be adjacent with each other. The set of cathode layers 130 and the set of anode layers 135 can be electrically coupled with one another in succession. Each cathode layer 130 can be electrically coupled with one of the anode layers 135. Each anode layer 135 can be electrically coupled with one of the cathode layers 130. Each cathode layer 130, each anode layer 135, each electrolyte layer 140 can be arranged longitudinally within the cavity 125. Each cathode layer 130, each anode layer 135, and each electrolyte layer 140 can at least partially extend from the bottom surface 115 to the top surface 110. Each cathode layer 130, each anode layer 135, each electrolyte layer 140 can be arranged laterally within the cavity 125. Each cathode layer 130, each anode layer 135, and each electrolyte layer 140 can at least partially extend from one side wall 120 to another side wall 120.

The electrolyte layer 140 can include at least one first side 230. The first side 230 can correspond to one surface of the electrolyte layer 140. The first side 230 can correspond to the surface facing the cathode layer 130. The cathode layer 130 can be disposed within the cavity 125 at least partially along the first side 230 of the electrolyte layer 140. At least one side of the cathode layer 130 can be in contact or flush with at least a portion of the first side 230 of the electrolyte layer 140. The cathode layer 130 can be electrically coupled with the electrolyte layer 140 through the first side 230. During operation of the battery cell 100 (e.g., charging or discharging), the cathode layer 130 can release lithium material into the electrolyte layer 140 through the first side 230. The lithium material released by the cathode layer 130 can move as cations through the electrolyte layer 140 and toward the anode layer 135 on the other side of the electrolyte layer 140.

The electrolyte layer 140 can include at least one second side 235. The second side 235 can correspond to another surface of the electrolyte layer 130. The second side 235 can correspond to the surface facing the anode layer 135. The anode layer 135 can be disposed within the cavity 125 at least partially along the second side 235 of the electrolyte layer 140. At least one side of the anode layer 135 can be in contact or flush with at least a portion of the second side 235 of the electrolyte layer 140. The anode layer 135 can be electrically coupled with the electrolyte layer 140 through the second side 235. During operation of the battery cell 100, the anode layer 135 can receive the lithium material conveyed through the electrolyte layer 140 via the second side 235.

Between the cathode layer 130 and the anode layer 135, a negative-to-positive (NP) capacity ratio can range between 1.2 to 1.5. The NP capacity ratio can be a proportion between a positive electrode capacity of the cathode layer 130 and a negative electrode capacity of the anode layer 135. The positive electrode capacity can refer to an amount of potential current that the cathode layer 130 can carry per mass (specific or gravimetric capacity), area (areal capacity), or volume (volumetric capacity) of the cathode layer 130. The positive electrode capacity can correlate with an amount of lithium ions released by the cathode layer 130 during charging. The negative electrode capacity can refer to an amount of potential current that the anode layer 135 can carry per mass (specific or gravimetric capacity), area (areal capacity), or volume (volumetric capacity) of the anode layer 135. The negative electrode capacity can correlate with an amount of lithium ions to be received by the anode layer 135 during charging. The cathode layer 130 can have the positive electrode capacity ranging between 3.0 mAh/cm² and 10 mAh/cm². The anode layer 135 can have the negative electrode capacity ranging between 500 mAh/g to 2500 mAh/g (specific capacity) or at least 3.5 mAh/cm² and 10 mAh/cm² (areal capacity). The negative electrode capacity of the anode layer 135 can be 20% to 50% greater than the positive electrode capacity of the cathode layer 130. In contrast, for battery cells with NP capacity ratios of between 1.0 to 1.1, the negative electrode capacity can range between 350 mAh/g to 4200 mAh/g (specific capacity) or lower than 10 mAh/cm² (areal capacity).

By increasing the NP capacity ratio from parity (e.g., 1.0 to 1.1 range) to higher than unity (e.g., 1.2 to 1.5 range), the anode layer 135 can have a greater negative electrode capacity loaded onto the negative conductive layer 225. Furthermore, the higher negative electrode capacity can allow to the silicon-carbon structure of the anode layer 135 to absorb and consume more of the lithium ion received via the electrolyte layer 140. In this manner, reactions leading to parasitic irreversibility with the lithium material accumulating between the anode layer 135 and the electrolyte layer 140 can be reduced or eliminated. Furthermore, the NP capacity ratio set to 1.2 to 1.5 range can lower the likelihood of the formation of a solid electrolyte interphase (SEI) between the anode layer 135 and the electrolyte layer 140 and the likelihood of lithium plating along the anode layer 135 and the negative conductive layer 225. The energy density of the overall battery cell 100, however, may be decreased as a result of the increase in the NP capacity ratio and the greater mismatch in the capacities of the cathode layer 130 and the anode layer 135. The energy density of a battery cell with the NP capacity ratio set between 1.0 to 1.1 can range between 500 Wh/L to 750 Wh/L or 600 mAh/cc to 800 mAh/cc. In comparison, the energy density of the battery cell 100 with the NP capacity ratio set between 1.2 to 1.5 can range between 750 Wh/L and 1000 Wh/L or 800 mAh/cc to 200 mAh/cc. The decrease in the energy density resulting from the increased NP capacity ratio may be considered undesirable, without consideration of the addition configurations of the battery cell 100 detailed herein.

The anode layer 135 can have or can be comprised of a silicon-carbon (SiC) (also referred herein as carborundum) structure to accommodate for both volume expansion and parasitic irreversibility. The silicon-carbon structure of the anode layer 135 can be of any polytype with any crystal lattice structure, such as cubic (3C(β)) or hexagonal (4H or 6H (α)). The silicon-carbon structure can be comprised of silicon and carbon substances. The ratio of silicon to carbon in the silicon-carbon structure of the anode layer 135 can range between 10 w % to 100 w %. At least one side of the silicon-carbon structure of the anode layer 135 can be flush or in contact with the second side 235 of the electrolyte layer 140. The silicon-carbon structure of the anode layer 135 can interface with the electrolyte layer 140 via the second side 235. The silicon-carbon structure of the anode layer 135 can be electrically coupled with the electrolyte layer 140 through the second side 235. The silicon-carbon structure of the anode layer 135 can receive lithium ion via the second side 235 of the electrolyte layer 140 during charging of the battery cell 100.

Prior to the initial operation of the battery cell 100 (e.g., charging or discharging), the silicon-carbon structure of the anode layer 135 can be doped with lithium material to increase the energy density of the battery cell 100. The silicon-carbon structure of the anode layer 135 can be doped with the lithium material using various techniques, such as physical solid-solid reaction or electrochemical lithiation, among others. The silicon-carbon structure of the anode layer 135 can include or can be infused or doped with solid electrolyte material with lithium. For example, the active material of the anode layer 135 can be mixed with a solid electrolyte material at a ratio ranging between 0 w % to 50 w %. The solid electrolyte material can include, for example, materials of the LGPS family (e.g., LiₐSi_{b}P_{c}S_{d}Clₑ, LiₐP_{c}S_{d}, and LiₐGe_{b}P_{c}S_{d}), a lithium super ion conductor (e.g., Li₂₊₂ₓZn₁₋ₓGeO₄), lithium lanthanum titanate (LiₐLa_{b}Ti_{c}O_{d}), lithium lanthanum zirconate (LiₐLa_{b}Zr_{c}O_{d}), among others. In battery cells with an NP capacity ratio near unity (e.g., 1.0 to 1.1), the anodes even with silicon and graphite can be initially free of lithium or have little lithium (e.g., less than 3%) to accommodate for lithium received via the electrolyte. On other hand, an NP capacity ratio higher than unity (e.g., 1.2 to 1.5) can allow for more lithium to be deposited in the anode layer 135, while also maintaining or increasing energy density. With the doping of the lithium material, the amount of activity material in the anode 135 can increase and the energy density of the battery cell 100 can range between 750 Wh/L to 1000 Wh/L or 800 mAh/cc to 1200 mAh/cc. The gross content of the lithium material within the silicon-carbon structure of the anode layer 135 can range between 3% to 50%. The minimum density of the lithium material can be set to increase the energy density. The maximum density of the lithium material can be set to allow for lithium to be absorbed into the silicon-carbon structure to reduce the likelihood of parasitic irreversibility forming between the anode layer 135 and the electrolyte layer 140. The gross content of the lithium material deposited in the anode layer 135 can depend on the ratio of silicon and carbon in the silicon-carbon structure. With the doping, the silicon-carbon structure of the anode layer 135 can have a charge capacity of 15 mAh/g to 1250 mAh/g in lithium content (sometimes referred herein as negative electrode capacity in lithium content).

The silicon-carbon structure of the anode layer 135 can be porous with a set of openings defined through the structure. The porous silicon-carbon structure of the anode layer 135 can accommodate the pre-doped lithium material. The porous silicon-carbon structure of the anode layer 135 can also accommodate lithium ion received via the electrolyte layer 140 during the operation of the battery cell 100. For example, upon receipt of the lithium ion from the electrolyte layer 140 into the anode layer 135, the lithium ion can occupy a position between two of the silicon or carbon atoms. In this manner, the porosity of the silicon-carbon structure of the anode layer 135 can reduce the likelihood and amount of volume expansion from the absorption of lithium by the silicon. With the amount of volume expansion reduced, the structural integrity of the housing 105 for the battery cell 100 can be preserved and maintained, thereby increasing the lifespan of the battery cell 100. The silicon-carbon structure of the anode layer 135 can have a porosity ranging between 5% and 40%. Each opening through the carbon-structure of the anode layer 135 can have a width (or diameter) ranging between 1 μm and 30 μm. The silicon-carbon structure of the anode layer 135 can be nanostructured. For example, the silicon-carbon structure of the anode layer 135 can be comprised of a set of nanoscale portions. Each portion can be comprised of the silicon-carbon material. The openings of the silicon-carbon structure can be defined as between at least two nanoscale portions. Each nanoscale portion can be an allotrope of silicon-carbon of any shape, such as a spherical, a flake, or a core/shell type, among others. Each nanoscale portion can have a height ranging between 1 μm and 30 μm. Each nanoscale portion can have a width (or diameter) ranging between 1 μm and 30 μm. Each nanoscale portion can have a length ranging between 1 μm and 30 μm.

With a higher energy density in the anode layer 135 from the pre-doping with the lithium material, the density of the anode layer 135 can be lowered to accommodate for volume expansion. The silicon-carbon structure anode layer 135 can have the density (sometimes referred herein as a tapped or bulk density) ranging between 0.5 g/cm³ to 2.3 g/cm³. Without the pre-doping of lithium material or use of a silicon-carbon structure, anodes in such battery cells can have a higher tap density with an aim of maintaining or increasing the energy density of the battery cell. For example, battery cells with a graphite anode can have an electrode density of 1.65 g/cm³ and battery cells with a graphite-silicon anode can have an electrode density ranging between 1.4 g/cm³ and 2.33 g/cm³. With doping, the density of the electrode density of the anode 135 can be decreased. In this manner, the lower tap density of the anode layer 135 can reduce the amount of volume expansion from the absorption of lithium by the silicon, as more space can be available to accommodate the lithium received from the electrolyte layer 140. In addition, with a lower tap density, more active material (e.g., lithium) can be added to silicon-carbon structure of the anode layer 135. The anode layer 135 can have the negative electrode ranging between 800 mAh/cm³ to 3000 mAh/cm³.

To juxtapose the characteristics of the battery cell 100 against battery cells without the same configuration (the anode layer 135 with the nanostructured silicon carbon):

| | | Anode | | Current | |
|---|---|---|---|---|---|
| Anode Type | Structure | Capacity | | Density | |
| Graphite Anode | Bulk | 350 | mAh/g | <6 | mAh/cm² |
| Graphite-Silicon | Bulk | 350-4200 | mAh/g | <6 | mAh/cm² |
| Anode | | | | | |
| Nanostructure | Prelithiated, | 500-2500 | mAh/g | >3.5 | mAh/cm² |
| Silicon Carbon | porous | | | | |
| Anode | structure | | | | |

| | Negative- | | Rechar- | |
|---|---|---|---|---|
| | Positive | Gross Li | geable Li | Electrode |
| Anode Type | Capacity Ratio | Content | Content | Density |
| Graphite Anode | 1.0-1.1 | 0 | 0 | <1.65 |
| Graphite-Silicon | 1.0-1.1 | 0 | 0 | 1.4-2.33 |
| Anode | | | | |
| Nanostructure | 1.2-1.5 | 3-50% | 15-1250 | <1.3 |
| Silicon Carbon | | | mAh/g | |
| Anode | | | | |

As a result of the configuration, the battery cell 100 can have an increased charge limit of 3C at 75% state of charge (SOC) under 5 mAh/cm². To contrast, battery cells with graphite anodes can have a charge limit of 1.5C at a 70% state of charge under 5 mAh/cm² and battery cells with graphite-silicon anodes can have a charge limit of 1.5C at 70% state of charge under 5 mAh/cm². The battery cell 100 can also have an improved cycle life with 85% after 500 cycles], whereas battery cells with graphite anodes can have a cycle life of 70% after 500 cycles and battery cells with graphite-silicon anodes can have a cycle life of 65% after 500 cycles. To summarize:

| | Charge Rate Limit | Cycle Life at 1000 cy |
|---|---|---|
| Anode Type | under 5 mAh/cm² | 1 C/1 C at RT |
| Graphite Anode | 1.5 C SOC 70% | 70 |
| Graphite-Silicon | 1.5 C SOC 75% | 65 |
| Anode | | |
| Nanostructure | 3 C SOC 75% | 85 |
| Silicon Carbon | | |
| Anode | | |

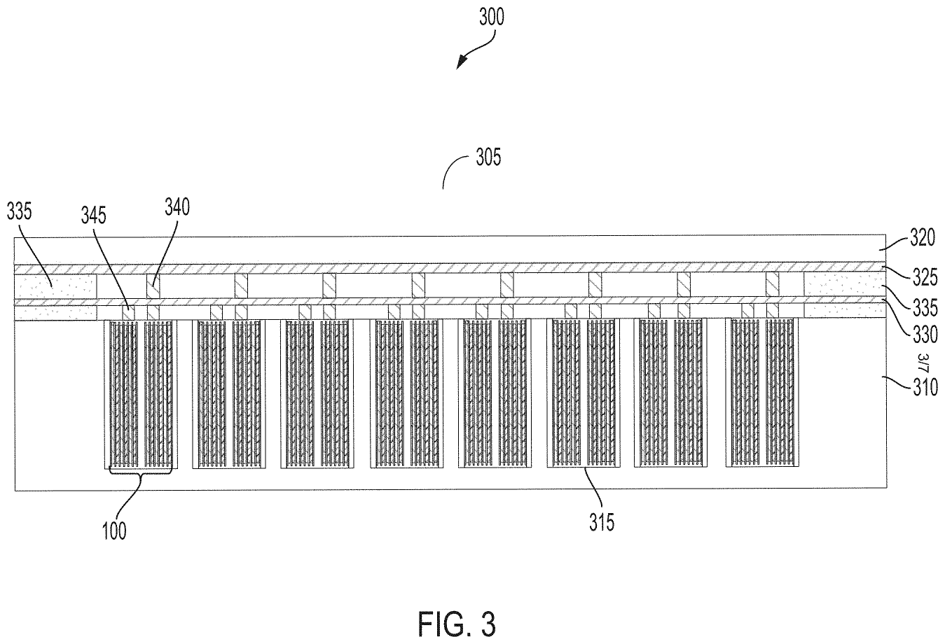

FIG. 3, among others, depicts a cross-section view of a system or an apparatus 300 for powering electric vehicles. The apparatus 300 can include battery module 305 (and each component of the battery module 305). The battery module 305 can hold a set of battery cells 105 in an electric vehicle. The battery module 305 can be part of the system or apparatus 100. The battery module 305 can be of any shape. The shape of the battery module 305 can be cylindrical with a circular, elliptical, or ovular base, among others. The shape of the battery module 305 can also be prismatic with a polygonal base, such as a triangle, a square, a rectangle (e.g., as depicted), a pentagon, and a hexagon, among others. The battery module 305 can have a length ranging between 10 cm to 200 cm. The battery module 305 can have a width ranging between 10 cm to 200 cm. The battery module 305 can have a height ranging between 65 mm to 100 cm.

The battery module 305 can include at least one battery case 310 and a capping element 320. The battery case 310 can be separated from the capping element 320. The battery case 310 can include or define a set of holders 315. Each holder 315 can be or include a hollowing or a hollow portion defined by the battery case 310. Each holder 315 can house, contain, store, or hold at least one battery cell 100. The battery case 310 can include at least one electrically or thermally conductive material, or combinations thereof. The capping element 320 can hold or secure the set of battery cells 100 within each holder 315. At least one side (e.g., a bottom side) of the capping element 320 can be mechanically coupled with at least one side (e.g., a top side) of the battery case 310.

Between the battery case 310 and the capping element 320, the battery module 305 can include at least one positive current collector 325, at least one negative current collector 330, and at least one electrically insulative layer 335. The positive current collector 325 and the negative current collector 330 can each include an electrically conductive material to provide electrical power to other electrical components in the electric vehicle. The positive current collector 325 (sometimes referred herein as a positive busbar) can be connected or otherwise electrically coupled with the positive conductive layer 210 of each battery cell 100 housed in the set of holders 315 via a bonding element 340. One end of the bonding element 340 can be bonded, welded, connected, attached, or otherwise electrically coupled to the positive conductive layer 230 of the battery cell 100 via the positive bonding element 205. The negative current collector 330 (sometimes referred herein as a negative busbar) can be connected or otherwise electrically coupled with the negative conductive layer 225 of each battery cell 100 housed in the set of holders 315 via a bonding element 345. The bonding element 345 can be bonded, welded, connected, attached, or otherwise electrically coupled to the negative conductive layer 225 of the battery cell 100 via the negative bonding element 220.

The positive current collector 325 and the negative current collector 330 can be separated from each other by the electrically insulative layer 335. The electrically insulative layer 335 can include spacing to pass or fit the positive bonding element 340 connected to the positive current collector 325 and the negative bonding element 330 connected to the negative current collector 330. The electrically insulative layer 335 can partially or fully span the volume defined by the battery case 310 and the capping element 320. A top plane of the electrically insulative layer 335 can be in contact or be flush with a bottom plane of the capping element 320. A bottom plane of the electrically insulative layer 335 can be in contact or be flush with a top plane of the battery case 310. The electrically insulative layer 335 can include any electrically insulative material or dielectric material, such as air, nitrogen, sulfur hexafluoride (SF₆), ceramic, glass, and plastic (e.g., polysiloxane), among others to separate the positive current collector 325 from the negative current collector 330.

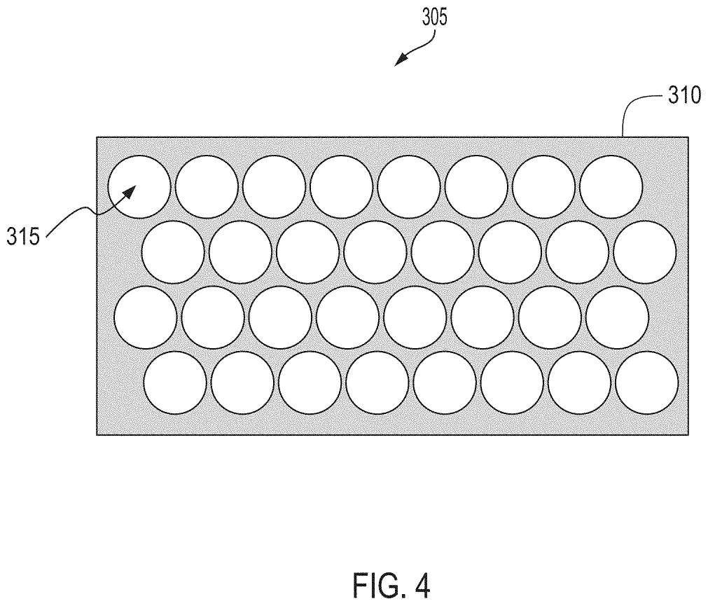

FIG. 4, among others, depicts a top-down view of the battery case 310 of the battery module 305 of the system or apparatus 300 to a hold a plurality of battery cells 100 in an electric vehicle. The battery module 305 can define or include a set of holders 315. The shape of each holder 315 can match a shape of the housing 105 of the battery cell 100. The shape of each holder 315 can be cylindrical with a circular (e.g., as depicted), elliptical, or ovular base, among others. The shape of each holder 315 can also be prismatic with a polygonal base, such as a triangle, a square, a rectangle, a pentagon, and a hexagon, among others. The shapes of each holder 315 can vary or can be uniform throughout the battery module 305. For example, some holders 315 can be hexagonal in shape, whereas other holders can be circular in shape. The dimensions of each holder 315 can be larger than the dimensions of the battery cell 100 housed therein. Each holder 315 can have a length ranging between 10 mm to 300 mm. Each holder 315 can have a width ranging between 10 mm to 300 mm. Each holder 315 can have a height (or depth) ranging between 65 mm to 100 cm.

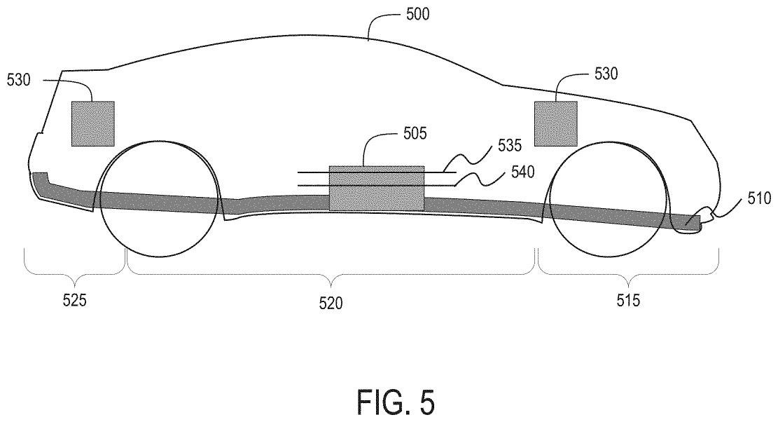

FIG. 5, among others, depicts a cross-section view of an electric vehicle 500 installed with a battery pack 505. The electric vehicle 500 can be an electric automobile (e.g., as depicted), hybrid, a motorcycle, a scooter, a passenger vehicle, a passenger or commercial truck, and another type of vehicle such as sea or air transport vehicles, a plane, a helicopter, a submarine, a boat, or a drone, among others. The electric vehicle 500 can include at least one chassis 510 (e.g., a frame, internal frame, or support structure). The chassis 510 can support various components of the electric vehicle 500. The chassis 510 can span a front portion 515 (e.g., a hood or bonnet portion), a body portion 520, and a rear portion 525 (e.g., a trunk portion) of the electric vehicle 500. The battery pack 505 can be installed or placed within the electric vehicle 500. The battery pack 505 can be installed on the chassis 510 of the electric vehicle 500 within the front portion 515, the body portion 520 (as depicted in FIG. 5), or the rear portion 525.

The electric vehicle 500 can include at least one battery pack 505. The battery pack 505 can be part of the apparatus 300. The battery pack 505 can be part of the system or apparatus 300. The battery pack 505 can house, contain, or otherwise include a set of one or more battery modules 305, among other components. The number of battery modules 300 in the battery pack 505 can range between 1 and 24, for example. The battery pack 505 can be of any shape. The shape of battery pack 505 can be cylindrical with a circular, elliptical, or ovular base, among others. The shape of battery pack 505 can also be prismatic with a polygonal base, such as a triangle, a square, a rectangle (e.g., as depicted), a pentagon, and a hexagon, among others. The battery pack 505 can have a length ranging between 100 cm to 500 cm. The battery pack 505 can have a width ranging between 100 cm to 400 cm. The battery pack 505 can have a height ranging between 70 mm to 1000 mm.

The electric vehicle 500 can include one or more components 530. The one or more components 530 can include an electric engine, an entertainment system (e.g., a radio, display screen, and sound system), on-board diagnostics system, and electric control units (ECUs) (e.g., an engine control module, a transmission control module, a brake control module, and a body control module), among others. The one or more components 530 can be installed in the front portion 515, the body portion 520, or the rear portion 525 of the electric vehicle 50. The battery pack 505 installed in the electric vehicle 500 can provide electrical power to the one or more components 530 via at least one positive current collector 535 and at least one negative current collector 540. The positive current collector 535 and the negative current collector 540 can be connected or otherwise be electrically coupled to other electrical components of the electric vehicle 500 to provide electrical power. The positive current collector 535 (e.g., a positive busbar) can be connected or otherwise electrically coupled with each positive current collector 535 of each battery module 305 in the battery pack 505. The negative current collector 540 (e.g., a negative busbar) can be connected or otherwise electrically coupled with each negative current collector 330 of each battery module 305 in the battery pack 505.

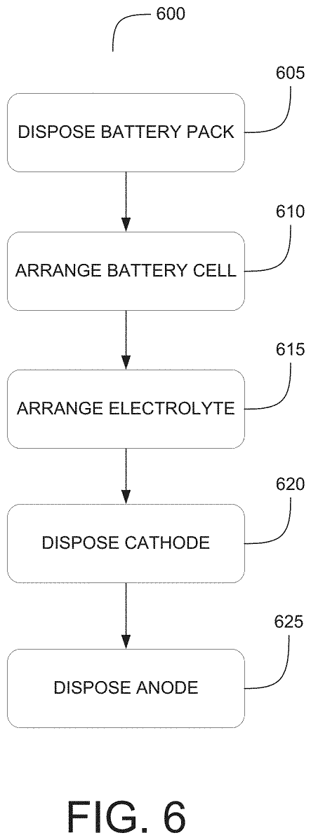

FIG. 6, among others, depicts a method 600 of providing battery cells for battery packs in electric vehicles. The functionalities of the method 600 can be implemented or performed using any of the systems, apparatuses, or battery cells detailed above in conjunction with FIGS. 1-5. The method 600 can include disposing a battery pack 505 (ACT 605). The battery pack 505 can be installed, arranged, or otherwise disposed in an electric vehicle 500. The battery pack 505 can house, contain, or include a set of battery modules 305. The battery pack 505 can store electrical power for one or more components 530 of the electric vehicle 500. The battery pack 505 can provide electrical power to the one or more components 530 via a positive current collector 535 and a negative current collector 540.

The method 600 can include arranging a battery cell 100 (ACT 610). The battery cell 100 can be a lithium-ion battery cell. The battery cell 100 can be stored or contained within a holder 315 of the battery module 800 included in the battery pack 1005. The battery cell 100 can include a housing 105. The housing 105 can be formed from a cylindrical casing with a circular, ovular, or elliptical base or from a prismatic casing with a polygonal base. The housing 105 can include a top surface 110, a bottom surface 115, and a sidewall 120. The housing 105 can have a cavity 125 to contain contents of the battery cell 105. The cavity 125 within the housing 105 can be defined by the top surface 110, the bottom surface 115, and the sidewall 120.

The method 600 can include arranging an electrolyte layer 140 (ACT 615). The electrolyte layer 140 can be comprised of a solid electrolyte material or a liquid electrolyte material. The material for the electrolyte layer 140 can be formed using deposition techniques, such as chemical deposition (e.g., chemical vapor deposition (CVD) or atomic layer deposition (ALD)) or physical deposition (e.g., molecular beam epitaxy (MBE) or physical vapor deposition (PVD)). For liquid electrolytes, the material for the electrolyte layer 140 can be doused or dissolved in an organic solvent. The electrolyte layer 140 can be fed, inserted, or otherwise placed into the cavity 125 of the housing 105 for the battery cell 100. The electrolyte layer 140 can at least partially span between the top surface 110, the bottom surface 115, and the sidewall 120 of the housing 105 for the battery cell 100.

The method 600 can include disposing a cathode layer 130 (ACT 620). The cathode layer 130 can be formed using deposition techniques, such as chemical deposition (e.g., chemical vapor deposition (CVD) or atomic layer deposition (ALD)) or physical deposition (e.g., molecular beam epitaxy (MBE) or physical vapor deposition (PVD)). The cathode layer 135 can be comprised of solid cathode materials, such as lithium-based oxide materials or phosphates. The cathode layer 130 can be placed or inserted into the cavity 125 of the housing 105 for the battery cell 100. The cathode layer 130 can be situated at least partially along the first side 230 of the electrolyte layer 140. The cathode layer 130 can output conventional electrical current into the battery cell 100. The cathode layer 130 can be electrically coupled with the positive conductive layer 210 also inserted into the cavity 130 in the housing 110 of the battery cell 105.

The method 600 can include disposing an anode layer 135 (ACT 625). The anode layer 135 can have a silicon-carbon (SiC) structure of any polytype with any crystal lattice structure. The silicon carbon structure of the anode layer 135 can be formed using deposition techniques, such as chemical deposition (e.g., chemical vapor deposition (CVD) or atomic layer deposition (ALD)) or physical deposition (e.g., molecular beam epitaxy (MBE) or physical vapor deposition (PVD)). The silicon carbon structure of the anode layer 135 can be formed by milling and thermal treatment process. The silicon carbon structure of the anode layer 135 can be fabricated to have a negative electrode capacity ranging between 500 mAh/g to 2500 mAh/g (specific capacity) or between 3.5 mAh/cm² to 10 mAh/cm² (areal capacity). The silicon carbon structure of the anode layer 135 can be manufactured to have a density of 1.3 g/cm³. In addition, the silicon carbon structure of the anode layer 135 can be doped with the lithium material using various techniques, such as physical solid-solid reaction or electrochemical lithiation, among others. The silicon carbon structure of the anode layer 135 can be doped to have a gross content ranging between 3 and 50%. The silicon carbon structure of the anode layer 135 can be doped to have a charge capacity of 15 mAh/g to 1250 mAh/g in lithium content.

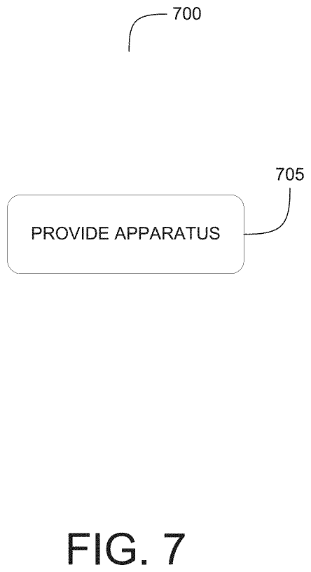

FIG. 7, among others, depicts a method 700 of providing battery cells for battery packs in electric vehicles. The functionalities of the method 700 can be implemented or performed using any of the systems, apparatuses, or battery cells detailed above in conjunction with FIGS. 1-5. The method 700 can include providing an apparatus 400 (ACT 705). The apparatus 300 can be installed in an electric vehicle 500. The apparatus 100 can include a battery pack 505 disposed in the electric vehicle 500 to power one or more components 530 of the electric vehicle 500. The battery pack 505 can include one or more battery modules 305. The apparatus 300 can include a set of battery cells 100. Each battery cell 100 can be arranged in the battery module 305. The battery cell 100 can include a housing 105. The housing 105 can include a top surface 110, a bottom surface 115, and a sidewall 120. The top surface 110, the bottom surface 115, and the sidewall 120 can define a cavity 125.

Within the cavity 125 defined by the housing 105, the battery cell 100 can have an electrolyte layer 140. The electrolyte layer 140 can have a first side 230 and a second side 235, and can transfer ions between the first side 230 and the second side 235. The battery cell 100 can have a cathode layer 130 disposed within the cavity 125 of the housing 105 along the first side 230 of the electrolyte layer 145. The cathode layer 130 can be electrically coupled with the positive terminal of the battery cell 100 via a positive conductive layer 210. The battery cell 100 can have an anode layer 135 disposed within the cavity 125 of the housing 105 along the second side 235 of the electrolyte layer 145. The anode layer 135 can have a silicon carbon structure. The silicon carbon structure can be porous and nanostructured. The silicon carbon structure of the anode layer 135 can be doped with lithium prior to an initial charging cycle of the battery cell 100. The gross content of the lithium in the silicon carbon structure can range between 3% to 50%. The charge capacity of the anode layer 135 can range between 15 mAh/g to 1250 mAh/g in content of the lithium material. The silicon carbon structure of the anode layer 135 can have a density of less than 1.3 g/cm³. The anode layer 135 The anode layer 135 can have a negative electrode capacity 20% to 50% greater than a positive electrode capacity of the cathode layer 130. The anode layer 135 can be electrically coupled with the negative terminal of the battery cell 100 via a negative conductive layer 225.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

Systems and methods described herein may be embodied in other specific forms without departing from the characteristics thereof. For example, descriptions of positive and negative electrical characteristics may be reversed. For example, elements described as negative elements can instead be configured as positive elements and elements described as positive elements can instead by configured as negative elements. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus to power electric vehicles, comprising:
a battery pack disposed in an electric vehicle to power the electric vehicle; and
a battery cell arranged in the battery pack, the battery cell having a housing that defines a cavity within the housing of the battery cell, the battery cell having:
an electrolyte having a first side and a second side to transfer ions between the first side and the second side, the electrolyte arranged within the cavity;
a cathode disposed within the cavity along the first side of the electrolyte, the cathode electrically coupled with a positive terminal, the cathode having a positive electrode capacity; and
an anode disposed within the cavity along the second side of the electrolyte, the anode having a silicon-carbon structure doped with lithium material prior to an initial charge cycle of the battery cell, the anode having a negative electrode capacity 20-50% greater than the positive electrode capacity of the cathode, the anode electrically coupled with a negative terminal.

2. The apparatus of claim 1, comprising:
the silicon-carbon structure of the anode doped with a gross content of the lithium material ranging between 3-50% to reduce parasitic reaction between the silicon-carbon structure of the anode and the second side of the electrolyte.

3. The apparatus of claim 1, comprising:
the silicon-carbon structure of the anode having a plurality of openings to accommodate volume expansion of silicon material in the silicon-carbon structure concurrent to operation of the battery cell.

4. The apparatus of claim 1, comprising:
the silicon-carbon structure having an electrode density of less than 1.3 g/cm³ to accommodate volume expansion of silicon material in the silicon-carbon structure.

5. The apparatus of claim 1, comprising:
the silicon-carbon structure of the anode having a charge capacity ranging from 15 mAh/g to 1250 mAh/g in content of the lithium material.

6. The apparatus of claim 1, comprising:
the silicon-carbon structure of the anode having a thickness ranging from 1 μm to 50 μm.

7. The apparatus of claim 1, comprising:
the battery cell having a charge rate limit ranging between 3C to 4C.

8. The apparatus of claim 1, comprising:
the silicon-carbon structure of the anode having an outer surface, at least a portion of the outer surface of the silicon-carbon structure in contact with the second side of the electrolyte.

9. The apparatus of claim 1, comprising:
the silicon-carbon structure of the anode to receive additional lithium material from the cathode via the electrolyte concurrent with operation of the battery cell within the electric vehicle.

10. The apparatus of claim 1, comprising:
the cathode of the battery cell including lithium material to be transferred to the anode via the electrolyte concurrent with operation of the battery cell within the electric vehicle.

11. The apparatus of claim 1, comprising:
the battery pack installed in the electric vehicle to power one or more components of the electric vehicle.

12. A method of providing battery cells to power electric vehicles, comprising:
disposing a battery pack in an electric vehicle to power the electric vehicle;
arranging, in the battery pack, a battery cell having a housing that defines a cavity within the housing of the battery cell;
arranging, within the cavity of the battery cell, an electrolyte having a first side and a second side to transfer ions between the first side and the second side;
disposing, within the cavity along the first side of the electrolyte, a cathode electrically coupled with a positive terminal, the cathode having a positive electrode capacity;
disposing, within the cavity along the second side of the electrolyte, an anode having a silicon-carbon structure that is doped with lithium material prior to an initial charge cycle of the battery cell, the anode having a negative electrode capacity 20-50% greater than the positive electrode capacity of the cathode, the anode electrically coupled with a negative terminal.

13. The method of claim 12, comprising:
doping the silicon-carbon structure of the anode with a gross content of the lithium material ranging between 3-50% to reduce parasitic reaction between the silicon-carbon structure of the anode and the second side of the electrolyte.

14. The method of claim 12, comprising:
disposing, within the cavity along the second side of the electrolyte, the anode having the silicon-carbon structure, the silicon-carbon structure having a plurality of openings to accommodate volume expansion of silicon material in the silicon-carbon structure concurrent to operation of the battery cell.

15. The method of claim 12, comprising:
disposing, within the cavity along the second side of the electrolyte, the anode having the silicon-carbon structure, the silicon-carbon structure having an electrode density of less than 1.3 g/cm³ to accommodate volume expansion of silicon material in the silicon-carbon structure.

16. The method of claim 12, comprising:
disposing, within the cavity along the second side of the electrolyte, the anode having the silicon-carbon structure, the silicon-carbon structure having a charge capacity ranging from 15 mAh/g to 1250 mAh/g in content of the lithium material.

17. An electric vehicle, comprising:
one or more components;
a battery pack to power the one or more components;
a battery cell arranged in the battery pack, the battery cell having a housing that defines a cavity within the housing of the battery cell, the battery cell having:
an electrolyte having a first side and a second side to transfer ions between the first side and the second side, the electrolyte arranged within the cavity;
a cathode disposed within the cavity along the first side of the electrolyte, the cathode electrically coupled with a positive terminal, the cathode having a positive electrode capacity; and
an anode disposed within the cavity along the second side of the electrolyte, the anode having a silicon-carbon structure that is doped with lithium material prior to an initial charge cycle of the battery cell, the anode having a negative electrode capacity 20-50% greater than the positive electrode capacity of the cathode, the anode electrically coupled with a negative terminal.

18. The electric vehicle of claim 17, comprising:
the silicon-carbon structure of the anode doped with a gross content of the lithium material ranging between 3-50% to reduce parasitic reaction between the silicon-carbon structure of the anode and the second side of the electrolyte.

19. The electric vehicle of claim 17, comprising:
the silicon-carbon structure having an electrode density of less than 1.3 g/cm³ to accommodate volume expansion of silicon material in the silicon-carbon structure.

20. The electric vehicle of claim 17, comprising:
the silicon-carbon structure of the anode having the negative electrode capacity ranging from 15 mAh/g to 1250 mAh/g in content of the lithium material.
